(19) United States
(12) Patent Application Publication
(10) Pub. No.: US 2009/0223469 A1
(43) Pub. Date: Sep. 10, 2009

(54) BALANCE SHAFT DRIVE SYSTEM

(75) Inventors: Frederick J. Rozario, Fenton, MI (US); Mark Stabinsky, Troy, MI (US); Joseph E. Robbins, Mayville, MI (US); Steven W. Merricle, Warren, MI (US); William C. Albertson, Clinton Township, MI (US)

Correspondence Address: Harness Dickey & Pierce, P.L.C., P.O. Box 828, Bloomfield Hills, MI, 48303, US

(73) Assignee: GM GLOBAL TECHNOLOGY OPERATIONS, INC., DETROIT, MI (US)

(21) Appl. No.: 12/045,147

(22) Filed: Mar. 10, 2008

(51) Int. Cl. F02B 75/06; F01L 1/02; F01L 1/344

(52) U.S. Cl. 123/90.17; 123/90.31; 123/192.2; 464/1

(57) ABSTRACT

An engine assembly may include an engine structure, a crankshaft, a camshaft, a balance shaft, and first and second gears. The crankshaft, camshaft, and balance shaft may each be rotatably supported by the engine structure. The camshaft may be rotationally driven by the crankshaft and the first gear may be coupled to the camshaft. The second gear may be fixed for rotation with the balance shaft and meshingly engaged with and driven by the first gear.

### FIELD

The present disclosure relates to engine assemblies including a balance shaft, and more specifically to drive arrangements for balance shafts.

### BACKGROUND

The statements in this section merely provide background information related to the present disclosure and may not constitute prior art.

Depending on the number and arrangement of cylinders, engines may exhibit inherent unbalanced forces resulting from the acceleration and deceleration of pistons. These forces may be a function of the reciprocating mass, engine stroke, connecting rod length, and crankshaft speed. The unbalanced forces, or imbalance, may produce undesirable noise and vibration. Some engines incorporate a balance shaft to counteract the imbalance. However, driving configurations for the balance shaft may be difficult to package, resulting in additional design complexity and cost.

### SUMMARY

An engine assembly may include an engine structure, a crankshaft, a camshaft, a balance shaft, and first and second gears. The crankshaft, camshaft, and balance shaft may each be rotatably supported by the engine structure. The camshaft may be rotationally driven by the crankshaft and the first gear may be coupled to the camshaft. The second gear may be fixed for rotation with the balance shaft and meshingly engaged with and driven by the first gear.

Alternatively, an engine assembly may include an engine structure, a crankshaft, a camshaft, a cam phaser, and a balance shaft. The crankshaft, camshaft, and balance shaft may each be rotatably supported by the engine structure. The cam phaser may be coupled to the camshaft and rotationally driven by the crankshaft. The balance shaft may be rotationally driven by the cam phaser.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of an engine assembly according to the present disclosure;

FIG. 2 is an exploded view of a camshaft assembly of the engine assembly of FIG. 1; and

FIG. 3 is an exploded view of a cam phaser assembly of the engine assembly of FIG. 1.

### DETAILED DESCRIPTION

The following description is merely exemplary in nature and is not intended to limit the present disclosure, application, or uses. It should be understood that throughout the drawings, corresponding reference numerals indicate like or corresponding parts and features.

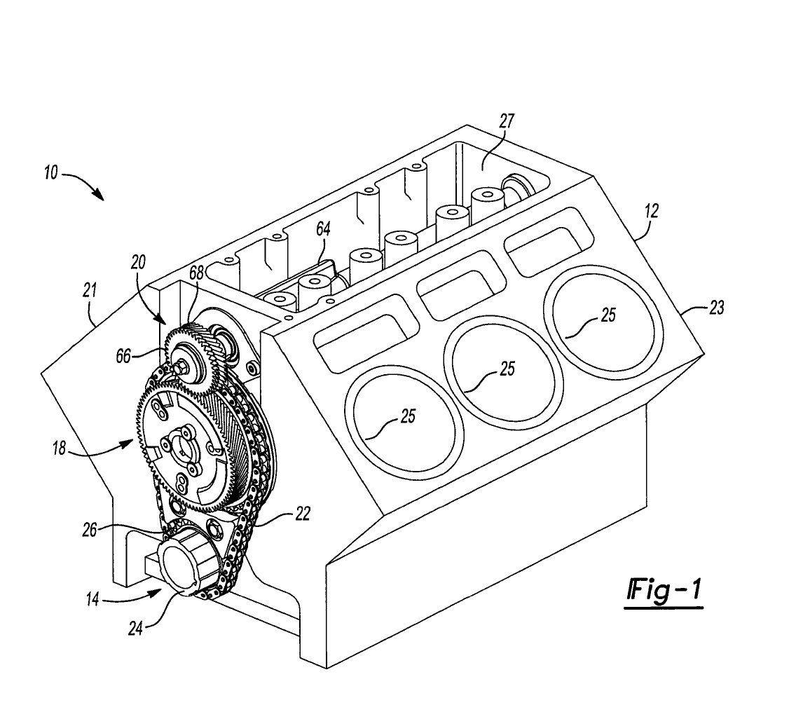

Referring now to FIGS. 1-3, an exemplary engine assembly 10 is illustrated. The engine assembly 10 may include an engine block 12, a crankshaft assembly 14, a camshaft assembly 16, a cam phaser assembly 18, a balance shaft assembly 20, and a drive belt 22. The crankshaft assembly 14, camshaft assembly 16, and balance shaft assembly 20 may each be rotatably supported by the engine block 12. The engine block 12 may define first and second banks of cylinders 21, 23 including first and second sets of cylinders 25 disposed at an angle relative to one another and defining a valley 27 between the first and second banks of cylinders 21, 23.

The crankshaft assembly 14 may include a crankshaft (not shown) and a drive hub 24 fixed to an end of the crankshaft. The drive hub 24 may include a series of teeth 26 engaged with the drive belt 22. The drive belt 22 may include a chain belt and may be engaged with the drive hub 24 of the crankshaft and the cam phaser assembly 18 to drive rotation of the cam phaser assembly 18 based on rotation of the crankshaft, as discussed below.

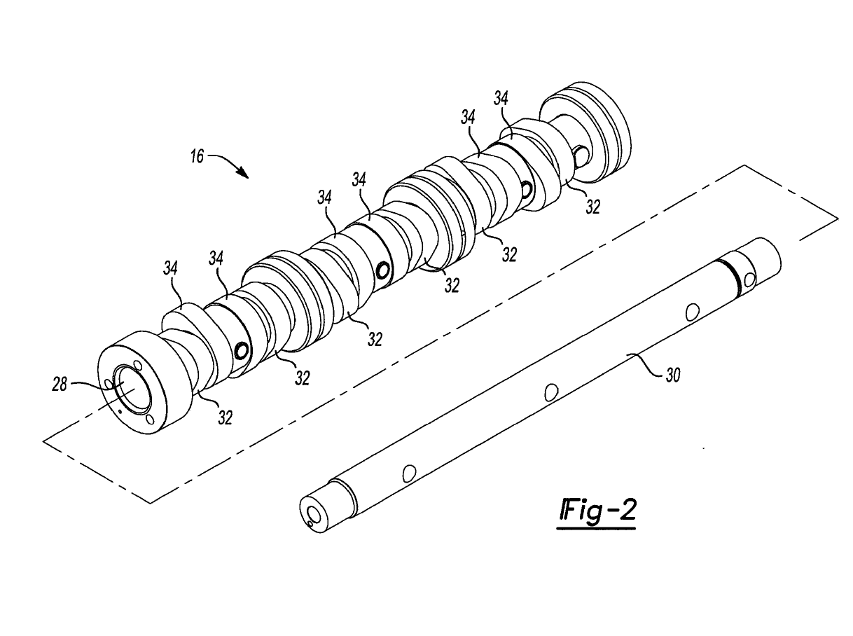

With reference to FIG. 2, the camshaft assembly 16 may form a concentric camshaft. The camshaft assembly 16 may be located between the first and second banks of cylinders 21, 23 and may include first and second shafts 28, 30, a first set of lobe members 32 and a second set of lobe members 34. The first set of lobe members 32 may be fixed for rotation with the first shaft 28 and the second set of lobe members 34 may be fixed for rotation with the second shaft 30. In the present example, the first set of lobe members 32 may form an intake lobe set and the second set of lobe members 34 may form an exhaust lobe set. However, it is understood that alternate arrangements may be provided where the first set of lobe members 32 may form an exhaust lobe set and the second set of lobe members 34 may form an intake lobe set.

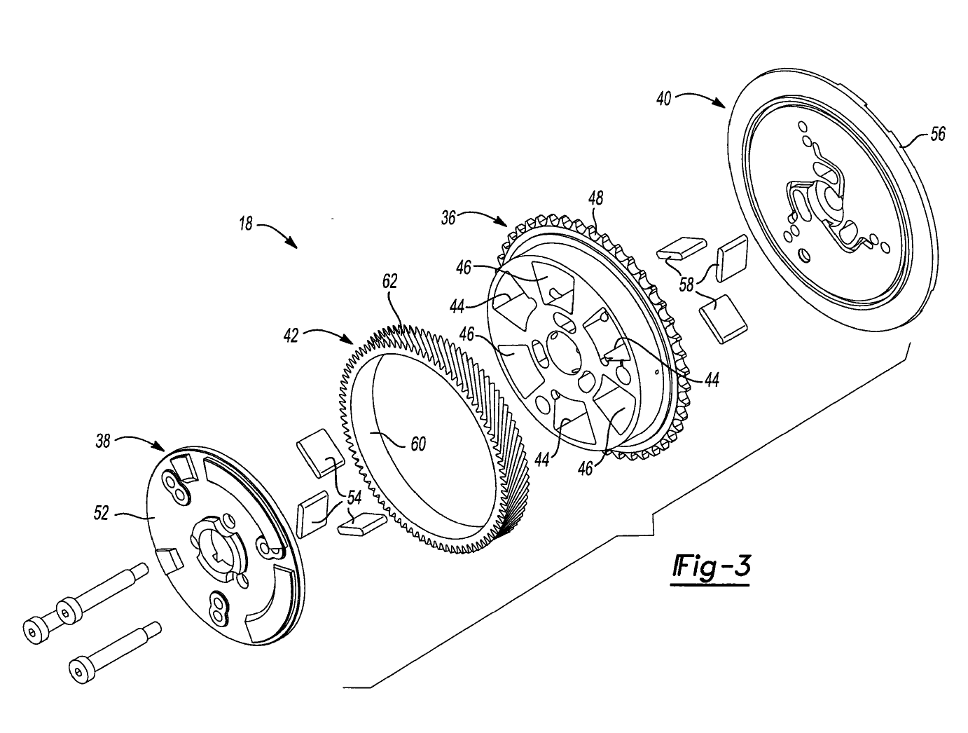

With reference to FIG. 3, the cam phaser assembly 18 may include first, second, and third portions 36, 38, 40 and a gear 42. The first portion 36 may form an oil chamber housing defining first and second sets of chambers 44, 46 and an outer hub 48 including a series of teeth 50 engaged with the drive belt 22. The second portion 38 may form a first plate assembly fixed to the first shaft 28 of the camshaft assembly 16 and including a first plate 52 and a first series of vanes 54 fixed for rotation with the first plate 52. The first series of vanes 54 may be located in the first set of chambers 44 of the first portion 36. The third portion 40 may form a second plate assembly fixed to the second shaft 30 of the camshaft assembly 16 and including a second plate 56 and a second set of vanes 58 fixed for rotation with the second plate 56. The second series of vanes 58 may be located within the second set of chambers 46 of the first portion 36.

The gear 42 may be formed from powdered metal and may include an annular body 60 with helical gear teeth 62. The gear 42 may be fixed for rotation with the first portion 36 of the cam phaser assembly 18. For example, the gear 42 may be frictionally engaged with the first portion 36 of the cam phaser assembly 18.

The drive belt 22 may be engaged with the gear 42 to drive rotation of the first portion 36 of the cam phaser assembly 18. The rotation of the first portion 36 may be transferred to the second and third portions 38, 40 by pressurized fluid within the first and second sets of chambers 44, 46 acting on the first and second sets of vanes 54, 58. As such, the camshaft assembly 16 may generally be fixed for rotation with the gear 42 as well. While the camshaft assembly 16 is illustrated as a concentric camshaft and the cam phaser assembly 18 is illustrated as a dual-independent cam phaser, it is understood that the present teachings apply equally to fixed-lobe camshafts and dual equal cam phasers.

As seen in FIG. 1, the balance shaft assembly 20 may be located between the first and second banks of cylinders 21, 23 and may include a balance shaft 64 and a gear 66. The balance shaft 64 may be located within the valley 27 of the engine block 12 and may be fixed for rotation with the gear 66. The gear 66 may be formed from powdered metal and may include a scissors gear. A scissors gear may include a gear assembly (such as gear 66) and a torque generating element (not shown) to reduce backlash and noise between drive and driven gears. The gear 66 may include gear teeth 68 meshingly engaged with the gear teeth 62 on the gear 42 fixed to the cam phaser assembly 18. The gear 66, and therefore the balance shaft 64, may be driven by the gear 42 in a rotational direction generally opposite the rotational direction of the drive belt 22 and the gear 42. The number of gear teeth 68 may be less than the number of gear teeth 62 to provide an increased rotational speed of the balance shaft 64 relative to the camshaft assembly 16. For example, the number of gear teeth 68 may be less than or equal to one-half of the number of gear teeth 62 to provide a rotational speed of the balance shaft 64 that is greater than the rotational speed of the camshaft assembly 16, and more specifically, greater than the rotational speed of the crankshaft. The gear 42 may be located between the drive hub 24 and the gear 66.

During operation, rotation of the crankshaft drive hub 24 may drive the belt 22 to power rotation of the cam phaser assembly 18, and therefore the camshaft assembly 16. Rotation of the cam phaser assembly 18 may be transferred to the balance shaft 64 through the engagement between the gears 42, 66.

What is claimed is:

1. An engine assembly comprising:
an engine structure;
a crankshaft rotatably supported by the engine structure;
a camshaft rotatably supported by the engine structure and rotationally driven by the crankshaft;
a first gear coupled to the camshaft;
a balance shaft rotatably supported by the engine structure; and
a second gear fixed for rotation with the balance shaft and meshingly engaged with and driven by the first gear.

2. The engine assembly of claim 1, wherein the engine structure includes an engine block rotatably supporting the camshaft.

3. The engine assembly of claim 2, wherein the engine block defines first and second sets of cylinders disposed at an angle relative to one another and the balance shaft is located between the first and second sets of cylinders.

4. The engine assembly of claim 3, wherein the camshaft is located between the crankshaft and the balance shaft.

5. The engine assembly of claim 1, wherein the second gear includes a scissors gear.

6. The engine assembly of claim 1, wherein the first gear includes a helical drive gear.

7. The engine assembly of claim 1, further comprising a belt engaged with the crankshaft and the camshaft to drive rotation of the camshaft based on crankshaft rotation.

8. The engine assembly of claim 1, further comprising a cam phaser coupled to the camshaft and rotationally driven by the crankshaft, the cam phaser driving rotation of the camshaft.

9. The engine assembly of claim 8, wherein the first gear is fixed to the cam phaser for rotation with the cam phaser.

10. The engine assembly of claim 9, wherein the cam phaser includes first and second portions, the first gear fixed for rotation with the first portion and the second portion rotatable relative to the first portion and fixed to the camshaft to rotate the camshaft relative to the first portion.

11. The engine assembly of claim 10, wherein the camshaft includes intake and exhaust lobes that are fixed relative to one another.

12. The engine assembly of claim 10, wherein the cam phaser includes a third portion rotatable relative to the first portion, the camshaft including intake lobes fixed for rotation with the second portion and exhaust lobes fixed for rotation with the third portion.

13. The engine assembly of claim 1, wherein the first gear has a first set of teeth and the second gear includes a second set of teeth, the second gear having fewer teeth than the first gear to increase a rotational speed of the balance shaft relative to the camshaft.

14. The engine assembly of claim 13, wherein the balance shaft is driven at a rotational speed that is greater than a rotational speed of the crankshaft.

15. An engine assembly comprising:
an engine structure;
a crankshaft rotatably supported by the engine structure;
a camshaft rotatably supported by the engine structure;
a cam phaser coupled to the camshaft and rotationally driven by the crankshaft; and
a balance shaft rotatably supported by the engine structure and rotationally driven by the cam phaser.

16. The engine assembly of claim 15, wherein the engine structure includes an engine block rotatably supporting the camshaft.

17. The engine assembly of claim 16, wherein the engine block defines first and second sets of cylinders disposed at an angle relative to one another and the balance shaft is located between the first and second sets of cylinders.

18. The engine assembly of claim 15, further comprising a first gear fixed for rotation with the cam phaser and a second gear fixed for rotation with the balance shaft and meshingly engaged with the first gear, the second gear driven by the first gear and driving rotation of the balance shaft.

19. The engine assembly of claim 18, wherein the second gear includes a scissors gear.

20. The engine assembly of claim 15, wherein the cam phaser is driven at a first rotational speed by the crankshaft and the balance shaft is driven at a second rotational speed greater than the first rotational speed by the cam phaser.
